(19) United States
(12) Patent Application Publication
(10) Pub. No.: US 2003/0122806 A1
(43) Pub. Date: Jul. 3, 2003

(54) Soft proofing system

(76) Inventor: Christopher J. Edge, St. Paul, MN (US)

Correspondence Address: SHUMAKER & SIEFFERT, P. A., 8425 SEASONS PARKWAY, SUITE 105, ST. PAUL, MN, 55125, US

(21) Appl. No.: 10/039,668

(22) Filed: Dec. 31, 2001

(51) Int. Cl. G09G 5/00

(52) U.S. Cl. 345/204

(57) ABSTRACT

In one embodiment, the invention is directed to soft proofing system that incorporates one or more of the features to promote controlled viewing conditions. For example, the invention can provide a soft proofing system in which an administrator can control the proofing process by limiting or restricting the ability to view an image until acceptable viewing conditions have been met. The image may have an associated set of viewing conditions that can be specified by the administrator. Then, when the image is sent to a viewing station, the ability to view the image can be restricted until one or more viewing conditions have been met at that viewing station. With controlled viewing conditions, the soft proof reviewers obtain more uniform output. In this manner, the system can provide safeguards to ensure that the images viewed at the viewing station have acceptable color accuracy.

### FIELD

The invention relates to color imaging and, more particularly, to soft proofing systems.

### BACKGROUND

Soft proofing refers to a proofing process that makes use of a display device rather than a printed hard copy. Traditionally, color proofing techniques have relied on hard copy proofing, where proofs are printed and inspected to ensure that the images and colors on the print media look visually correct. For instance, color characteristics can be adjusted and successive hard copy prints can be examined in a hard proofing process. After determining that a particular proof is acceptable, the color characteristics used to make the acceptable proof can be reused to mass-produce, e.g., on a printing press, large quantities of print media that look visually equivalent to the acceptable proof.

Soft proofing is desirable for many reasons. For instance, soft proofing can eliminate or reduce the need to print hard copies on media during the proofing process. Moreover, soft proofing may allow multiple proofing specialists to proof color images from remote locations simply by looking at display devices. With soft proofing, there is no need to print and deliver hard copy proofs to remote reviewers. Thus, soft proofing can be faster and more convenient than hard copy proofing. Moreover, soft proofing can reduce the cost of the proofing process. For these and other reasons, soft proofing is highly desirable.

Realizing a high quality soft proofing system, however, has proven to be very difficult. In particular, the inability to accurately render colors of proofing quality on the display devices has generally limited the effectiveness of soft proofing. Color management tools and techniques have been developed to improve the accuracy of color matching between the outputs of different devices. However, even with color management tools, accurate color rendering of proofing quality continues to be challenging.

### SUMMARY

In general, the invention is directed to soft proofing systems that incorporate one or more of the features to promote controlled viewing conditions. The system may utilize color profiles for source and destination color matching such as CMYK prints to RGB display. In some embodiments, the invention provides a soft proofing system in which an administrator can control the proofing process by limiting or restricting the ability to view an image until acceptable viewing conditions have been met. The image may have an associated set of viewing conditions that can be specified by the administrator. Then, when the image is sent to a viewing station, the ability to view the image can be restricted until one or more viewing conditions have been met at that viewing station. With controlled viewing conditions, the soft proof reviewers obtain more uniform output. In this manner, the system provides safeguards to ensure that the images viewed at the viewing station have acceptable color accuracy.

The viewing conditions may operate in a manner analogous to password protection algorithms. In password protected files, the data cannot be accessed until a password has been correctly entered. In a similar manner, the invention can restrict the ability to view an image until viewing conditions have been met. In response to an attempt to open or render an image file at the viewing station, viewing software may monitor or automatically query the whether the specified viewing conditions are satisfied. If the viewing conditions are satisfied, the viewing software can direct an image to be displayed according to the image data. However, if the viewing conditions are not satisfied, the viewing software may restrict access and/or prompt the user to take steps necessary to satisfy the viewing conditions.

In one embodiment the invention may comprise a proofing system that includes a first computer that specifies one or more viewing conditions for an image, and a viewing station that displays the image subject to the viewing conditions. The viewing conditions may be specified by the administrator, and may comprise calibration information such as a minimum amount of time since the last calibration of the display device associated with a viewing station. In that case, the ability to view the image may be restricted if the display device at the viewing station has not been calibrated within the amount of time specified in the viewing conditions. In other examples, one or more viewing conditions may be queried by the viewing software automatically. In that case, an administrator would not be required to specify those viewing conditions. Rather the viewing software may automatically check one or more viewing conditions prior to opening an image file.

In another embodiment, the invention can be used to ensure that a display device has been adequately warmed up prior to viewing of images or calibration of the display device. In this manner, it can be further ensured that a viewing station renders accurate color images. For example, the amount of time that the display device has been turned on can be measured or determined. Then, the ability to view images can be restricted if the display device has not been turned on for an acceptable amount of time. Alternatively, a calibration procedure for the display device may be restricted if the display device has not been turned on for an acceptable amount of time in order to ensure that the calibration procedure is not performed prematurely. The warm-up technique can be performed independently of the administrative controlled viewing conditions, or in a combined embodiment, the acceptable amount of warm-up time may be one of the viewing conditions specified by the administrator.

In additional embodiments, the viewing conditions may comprise anything that affects how images appear on a display screen. For example, viewing conditions may specify required illuminant conditions surrounding a display device at a viewing station, the sharpening to be applied at the rendering device, or anything that affects the rendering on the display device. Again, the administrator may select the viewing conditions. Users at the viewing stations may be able to view different administrative selected viewing conditions, but may be unable to change them.

Various aspects of the invention may be implemented in hardware, software, firmware, or any combination thereof. If implemented in software, the invention may be directed to a computer readable medium carrying program code, that when executed, performs one or more of the methods described herein.

The invention can provide a number of advantages. For example, the invention can allow increased administrative control over the soft proofing process. This added control can better ensure that the images viewed at various viewing stations appear visually equivalent. Accurate and equivalent color rendering is imperative for the realization of a high quality and affective soft proofing system. If reviewers are examining different output, the effectiveness of soft proofing can be undermined. Thus, the invention can facilitate an improved soft proofing system by ensuring that the images rendered at different viewing stations appear visually equivalent. Furthermore, the administrative control can provide a safeguard to ensure that color specialists at viewing stations do not analyze incorrect renditions of color images. Even without administrative control, however, the invention may improve the soft proofing system by automatically monitoring viewing conditions.

Additional details of these and other embodiments are set forth in the accompanying drawings and the description below. Other features, objects and advantages will become apparent from the description and drawings, and from the claims.

### BRIEF DESCRIPTION OF THE DRAWINGS

FIG. 1 illustrates an exemplary soft proofing system according to an embodiment of the invention.

FIG. 2 is simplified block diagram of a soft proofing system according to an embodiment of the invention.

FIGS. 3-5 illustrate block diagrams of exemplary data structures that may be used to implement various aspects of the invention.

FIGS. 6 and 7 are block diagrams of exemplary implementations of viewing stations.

FIGS. 8 and 9 are flow diagrams illustrating soft proofing techniques according to embodiments of the invention.

FIGS. 10-12 are exemplary renditions on display screens at viewing stations implementing various aspects of the invention.

FIG. 13 is another flow diagram illustrating a soft proofing technique according to an embodiment of the invention.

FIG. 14 is another exemplary rendition on display screen at viewing station implementing various aspects of the invention.

FIG. 15 is another flow diagram illustrating a soft proofing technique according to an embodiment of the invention.

FIG. 16 is another exemplary rendition on display screen at viewing station implementing various aspects of the invention.

FIG. 17 is another flow diagram illustrating a soft proofing technique according to an embodiment of the invention.

### DETAILED DESCRIPTION

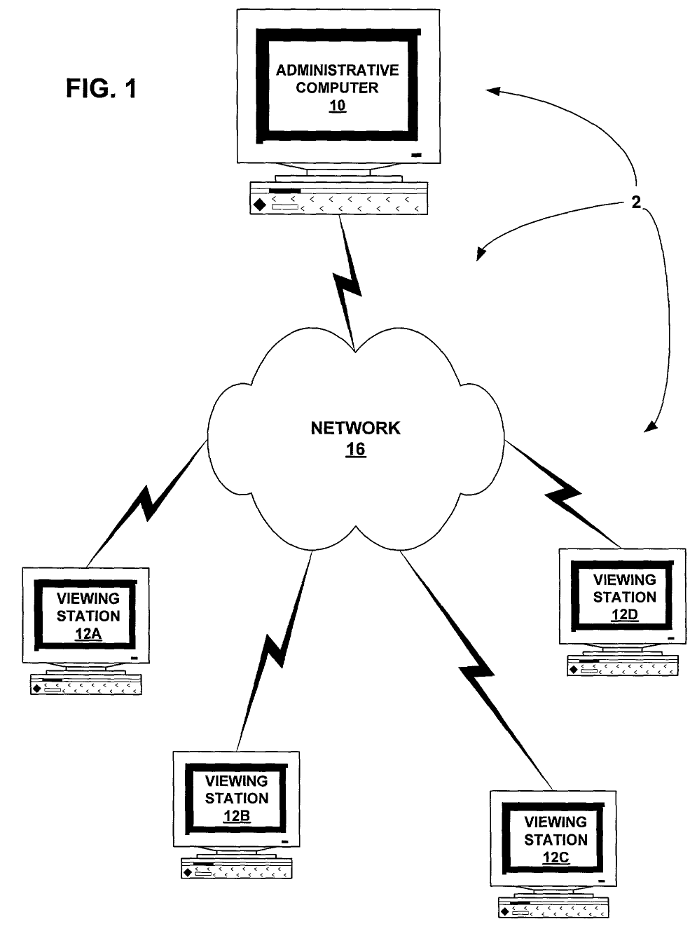

FIG. 1 illustrates an exemplary soft proofing system 2. Soft proofing system 2 may implement one or more aspects of the invention to realize more accurate color rendering and color matching in a soft proofing process. Soft proofing system 2 includes an administrative computer 10. Administrative computer 10 can be thought of as a server computer for soft proofing system 2. Administrative computer 10 may serve up images to viewing stations 12A-12D (hereafter viewing stations 12). Color specialists at viewing stations 12 can inspect the images, and possibly provide feedback by marking or highlighting the images and returning marked-up copies to administrative computer 10. Upon receiving feedback, an administrator may implement changes to the image using administrative computer 10. Once the administrator and the reviewers associated with viewing stations 12 reach agreement on the appearance of the color image, the image can be printed via a printing press or another high quality printing device.

Administrative computer 10 may be directly coupled to viewing stations 12, possibly forming a local area network (LAN). Alternatively, administrative computer 10 may be coupled to viewing stations 12 via a wide area network or a global computer network 16 such as the Internet. As described in greater detail below, an image served from administrative computer 10 may have viewing conditions associated therewith. The administrator may assign the viewing conditions to the image to better control the visual accuracy of the output viewed by reviewers associated with viewing stations 12. The ability to view the image can be restricted at the viewing stations when the viewing conditions have not been met. In this manner, the invention can provide better assurances that the images rendered at viewing stations 12 are more representative of the original image. Exemplary viewing conditions include an amount of time since a display device at the viewing station was last calibrated, an amount of warm-up time for the display device, specific illuminant conditions surrounding the display device of the viewing station, sharpening to be applied to the rendering device, or any other viewing condition that may affect the rendition of the image.

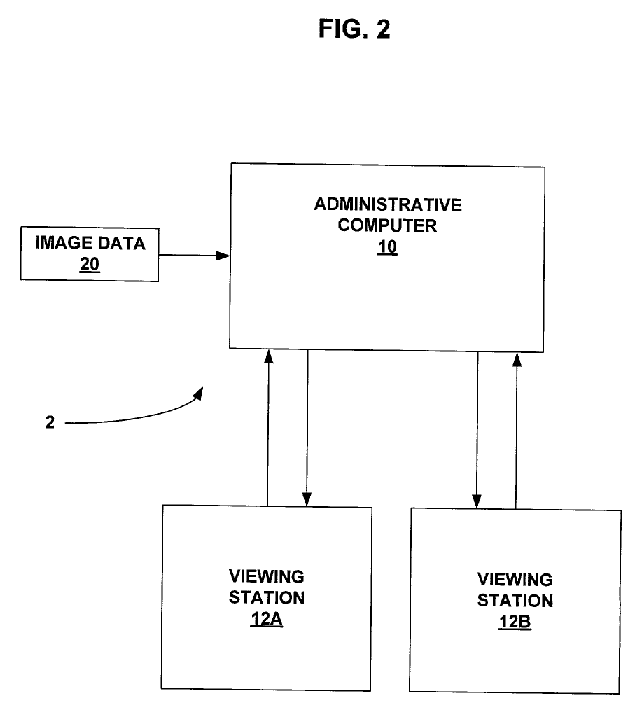

FIG. 2 is simplified block diagram of system 2. As shown, administrative computer 10 is coupled to a number of viewing stations 12. Image data 20 can be loaded into administrative computer 10 by an administrator. In other words, the “administrator” refers to a user that operates and controls administrative computer 10. Any person may be the administrator, but for effective soft proofing, it is advantageous to have an administrator that has imaging expertise. Exemplary administrators may include a proofing technician, a press technician, a graphic artist, advertisement agency personnel, or a color specialist. The administrator, in effect, takes “ownership” of an image, and exerts some degree of control over the manner in which the image may be reproduced by viewing stations. In this manner, the administrator can better ensure consistent and uniform output among the viewing stations so that the viewers are able to view images with substantially identical color characteristics.

Administrative computer 10 typically includes software that conditions or adjusts image data 20 so that it can be accurately rendered at viewing stations 12. Also, administrative computer 10 may include authoring software for creating the imagery. In accordance with the invention, the administrator can control the ability of viewing station 12 to render the image by specifying one or more viewing conditions. When the image is sent to viewing stations 12, the ability to view the image may be restricted until the specified viewing conditions have been met. In this manner, improved color accuracy can be provided between the image produced by administrative computer 10 and the corresponding images viewed by viewing stations 12.

In one specific implementation, when administrative computer 10 receives image data 20, generalized conversions, including raster image processing (RIP'ing) and conversion to a standard red-green-blue (RGB) color space can be performed by the administrative computer 10. In operation, the administrator may define a proof simulation within soft proofing system 2. For example, an image can be designated for a specific cyan-magenta-yellow-black (CMYK) proof simulation. In that case, the administrator can choose a specific International Color Consortium (ICC) profile for virtual proofing. The CMYK simulation can be set by the administrator, using password access. Non-administrators may be able to view and confirm which color simulation was chosen for the job, but may not be allowed to modify the choice. This arrangement provides enhanced administrator control of the simulations. In particular, viewing stations 12 can be configured so that individual reviewers are unable to adjust the selected simulation. Alternatively, viewing stations 12 may permit entry of an adjustment, but only in conjunction with a notification that the displayed image may not conform to the original image prepared by the administrator. For example, the notification may indicate that the image displayed by viewing station 12 may not be relied upon as a “contract” proof, unless the reviewer adheres to the proof simulation chosen by the administrator.

A list of CMYK simulations may reside on administrative computer 10 in the form of ICC device links (CMYK to RGB) generated from the source CMYK profile. The source CMYK profile can accurately characterize the proofing condition to be simulated. Different standard destination RGB color space information may also reside on administrative computer 10. For example, the administrator may choose the destination RGB space as Adobe RGB (also known as SMPTE-240) which is commonly utilized in software applications such as Adobe Photoshop, commercially available from Adobe Systems Inc. of San Jose, Calif. The white point can be set to D50 rather than the default white point, which is commonly D65. Choosing the white point of D50 is advantageous because it can better ensure that there will be no confusion in interpretation of the profile. In particular, some different ICC based systems may interpret the white point differently if it is not D50.

In accordance with the invention, the administrator can also select one or more additional viewing conditions for the image to be proofed. Administrative computer 10 can then send the image along with the viewing conditions to one or more viewing stations 12, either automatically or in response to specific requests from the viewing stations 12. The viewing conditions may be included within an image file, or sent separately. In either case, the ability to view the image at viewing stations 12 can depend on whether the viewing conditions have been met.

Additional conversions of the RGB data can be performed at each viewing station 12 via local hardware of software in the viewing station 12. In other words, each viewing station 12 may perform a color matching technique to convert from standard RGB (e.g., Adobe RGB) to local RGB for the specific display device associated with that viewing station 12. The local software can also analyze the viewing conditions specified by the administrator. If the viewing conditions have not been met, the local software in viewing station 12 can restrict the ability to view the image, and possibly instruct the user how to remedy the viewing conditions. Once the viewing conditions have been met at the viewing station, the local software may allow the image to be displayed and viewed on an unrestricted basis.

Referring again to FIG. 1, system 2 has been described as performing general CMYK to RGB conversions in administrative computer 10 and then performing specific RGB to RGB conversions in viewing stations 12. However, the invention is not necessarily limited in that respect. Rather, these conversions may be applied solely in the viewing stations 12, or even solely in administrative computer 10. In the later case, viewing stations 12 may communicate device specific information to administrative computer 10 so that the proper conversions can be made. In short, although many details of the invention are described in the context of one specific implementation of the various conversion processes, the invention is not necessarily limited to the manner in which these conversions take place or the location where the conversions take place.

Copending and commonly assigned application Ser. No. 09/808,875, to Chris Edge, filed Mar. 15, 2001 describes one specific conversion process that can yield accurate color matching results. In that case, image data of a hard copy CMYK image is converted from CMYK coordinates to XYZ coordinates, and the XYZ coordinates are then transformed to X′Y′Z′ coordinates. The transformed X′Y′Z′ coordinates can then be converted to RGB coordinates for presentation on a display device for soft proofing. To transform device-independent coordinates, a white point and chromatic colors can be separately corrected. As described in the aforementioned application, the bifurcated transformation process can yield very accurate color matching results. The described process includes obtaining a white point correction for a display device, obtaining a chromatic correction for the display device, and then generating corrected color coordinates based on the white point and chromatic corrections. Also, the use of correction matrices can further improve color matching accuracy. These techniques, or other color matching techniques can be implemented along with the administrative control techniques described herein to yield a soft proofing system that has improved color accuracy. The above-identified application is hereby incorporated by reference herein in its entirety.

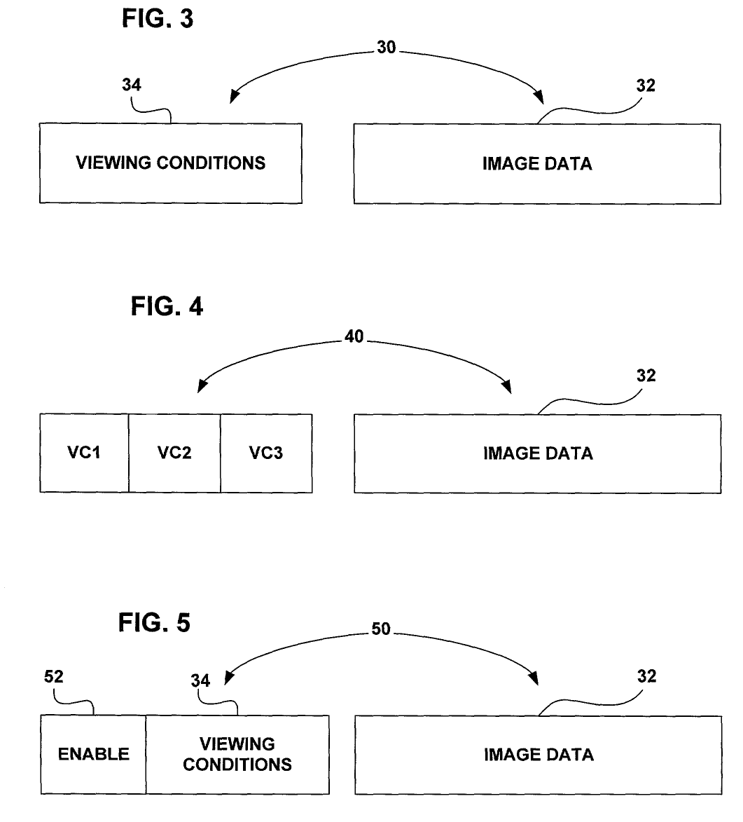

FIGS. 3-5 illustrate block diagrams of exemplary data structures that may be used to implement various aspects of the invention. Specifically, FIG. 3 illustrates a data structure 30 that includes image data 32 and data indicating viewing conditions 34. As described herein, viewing conditions 34 can be specified by an administrator to ensure that the images rendered using image data 32 will visually match the image prepared by the administrator. Upon receiving image data 32 and viewing conditions 34, viewing stations 12 may be unable to render the image until the viewing conditions have been met. More details of some specific implementations of viewing stations 12 are described below.

Data structure 30 can be realized in a number of different formats. For example, in one embodiment, data structure 30 comprises a single image file that includes both image data 32 and the administrator-specified viewing conditions 34. In that case, only the image file may need to be served from administrator 10 to viewing stations 12. For example, the image file may include the image data 32, with the viewing conditions stored as annotations, headers, or footers to the image file.

In another embodiment, data structure 30 can be realized as one or more data files stored independently of the image file. In that case, image data 32 and viewing conditions may comprise separate data files that are associated with one another in a database. For example, various database techniques can provide the ability to store “meta data” files associated with one or more image files. Data structure 30 may be easily implemented using such a database technique. In that case, image data 32 would have an associated meta data file that includes the viewing conditions 34. These files, then, could be served to a viewing station 12 together so that viewing station 12 receives the necessary data to display the image. Additionally, a “meta data” file may be associated with a folder of data files. In that case, viewing conditions may be selected for all images in the folder associated with the “meta data” file by setting the viewing conditions in that “meta data” file.

In another exemplary embodiment, data structure 30 could be associated with the processing parameters of a data file. In that case, image data 32 would be the data file and viewing conditions 34 would be included with the processing parameters. For example, Adobe Postscript™ interpreter software may provide the ability to specify processing parameters, conventionally used to indicate the desired resolution or size of the image processed by a raster image processor. The invention could be implemented by storing the viewing conditions 34 with the process parameters as described above. Furthermore, copending and commonly assigned U.S. application Ser. No. 09/867,055, filed May 29, 2001 for William A. Rozzi, entitled “EMBEDDING COLOR PROFILES IN RASTER IMAGE DATA USING DATA HIDING TECHNIQUES” describes a technique of embedding color data within raster image data using the art of steganography and is hereby incorporated herein by reference in its entirety. Accordingly, data structure 30 may even comprise raster image data with the viewing conditions embedded therein.

In another embodiment, data structure 30 may comprise an image file in which viewing conditions 34 are embodied as part of an algorithm stored within data structure 30. In that case, access to image data 32 may be restricted by the image file itself, unless the viewing conditions have been met. For example, data structure 30 may operate in a manner analogous to conventional password protected files. However, rather than prompting a user for a password, data structure 30 may prompt the reviewer or software associated with viewing station 12 to check the viewing conditions.

In FIG. 4, data structure 40 includes a number of distinct viewing conditions (VC1, VC2 and VC3). These parameters are subject to a wide variety of possible implementations. In one embodiment, the viewing conditions include calibration conditions such as minimum time since the last calibration, or a specific calibration procedure that must be applied. For example, if a viewing condition is chosen by the administrator to specify a minimum time X since the last calibration of the display device, viewing station 12 may restrict access to the image if the time since last calibration of the display device associated with viewing station 12 is greater than X. In that case, viewing station 12 may instruct the user to perform calibration on the display device in order to view the image. By restricting viewing unless calibration has occurred within time X, the administrator can ensure that significant drift has not occurred in the display device at viewing station 12. If drift has occurred, the calibration procedure will account for the drift accordingly. In this manner, more controlled and more uniform output across viewing stations 12 can be achieved.

Also, if a viewing condition parameter is chosen by the administrator to specify a particular calibration procedure, that procedure may need to be applied in order to view the image at viewing station 12. In some cases, for color-critical images such as contract proofs, the viewing conditions may require viewing station 12 to calibrate prior to viewing, without regard to the time since last calibration. This calibration can account for any drift that may have occurred in the display device at viewing station 12 since the last calibration.

Another possible viewing condition is a warm-up time for a display device. In that case, if a viewing condition is chosen by the administrator to specify a minimum warm-up time for the display device, viewing station 12 may be unable to render the image until the display device has adequately warmed up, i.e. powered up. Display devices often take a significant amount of time to warm up, and do not reach a steady viewing state until adequately warmed up. Thus, by ensuring that the display device has been adequately warmed up, a more uniform rendition of the image can be achieved across different viewing stations 12.

Other possible viewing conditions may relate to such things as external lighting surrounding a given viewing station 12, or any other possible parameter that can affect the appearance of an image rendered at one or more viewing stations 12. For example, if external lighting is one of the viewing conditions, a user may be required to calibrate the external lighting prior to viewing the image. Copending and commonly assigned U.S. application Ser. No. 09/867,053, filed May 29, 2001 for William A. Rozzi, entitled “DISPLAY SYSTEM” describes a display device having an associated illuminant condition sensor that senses illuminant conditions surrounding the display device, and is hereby incorporated herein by reference in its entirety. If the display device has an illuminant condition sensor, the viewing software may automatically cause the illuminant condition sensor to measure illuminant conditions. Accordingly, the image may be rendered at viewing station 12 only if the illuminant conditions are acceptable, or alternatively, the image may be adjusted to account for differences in illuminant conditions. This too can ensure that images rendered at different viewing stations 12 will look visually equivalent.

Another viewing condition that can be chosen by the administrator may include sharpening to be applied at the rendering device. For example, sharpening may improve color accuracy. In some cases, the viewing condition may specify a specific sharpening technique. For example, a technique that dynamically adjusts both scaling of the size of an image and the sharpening to be applied to that image may be specified as a viewing condition. In this manner, improved color accuracy may be achieved. Copending and commonly assigned U.S. Provisional Application Serial No. 60/280,184, filed Mar. 30, 2001 for Christopher Edge, entitled “AUTOMATED SHARPENING OF IMAGES FOR SOFT PROOFING” describes possible sharpening techniques that may be specified as a viewing condition, and is incorporated herein by reference in its entirety.

In FIG. 5, data structure 50 includes an enable field 52. The enable field 52 can be particularly useful if the administrator desires to send one or more images that do not require a high level of color accuracy. Thus, enable field 52 can be used by an administrator to enable or disable the operation of the viewing conditions 34. If an image is sent that does not require attention to a high level of color accuracy, the viewing conditions 34 may be disabled by the appropriate selection of field 52. In that case, viewing station 12 may still be able to display the image even if the viewing conditions have not been met. Alternatively, each particular viewing condition may include it own enable field. In that case, an administrator may selectively enable only particular viewing conditions as desired.

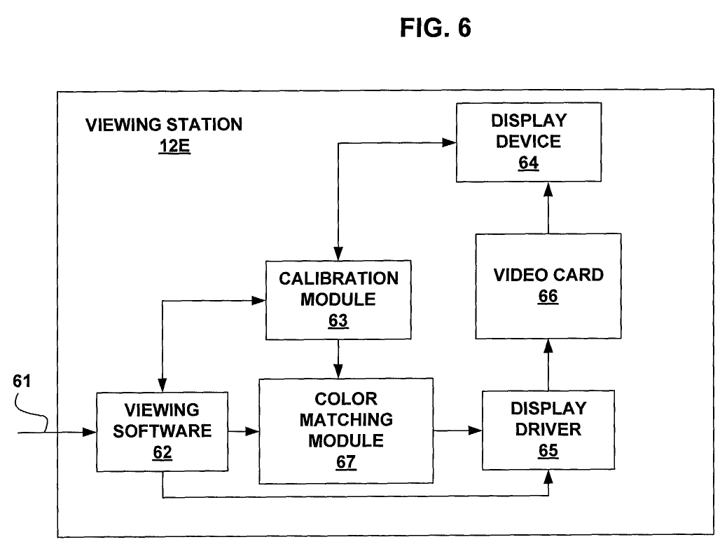

FIG. 6 is a block diagram of one exemplary implementation of a viewing station 12E according to the invention. Viewing station 12E may correspond to any viewing station 12A-12D illustrated in FIG. 1. As indicated by reference numeral 61, viewing station 12E receives RGB image data as well as viewing conditions specified by an administrator. In other words, numeral 61 indicates the reception of a data structure as illustrated and described above with reference to FIGS. 3-5. Viewing station 12E may include various components that can be implemented in software or hardware. As illustrated in FIG. 6, viewing station 12E includes viewing software 62, color matching module 67, display driver 65, video card 66 and display device 64. In addition, viewing station 12E includes calibration module 63 for calibrating the display device.

By way of example, the operation of viewing station 12E will now be described where the viewing conditions are calibration conditions that specify a minimum time since the last calibration. Upon receiving RGB image data as well as viewing conditions that specify a minimum time X since last calibration, viewing software 62 queries calibration module 63 to determine the last time calibration was performed. Calibration module 63 includes a calibration algorithm, or the like, for performing calibration of display 64. Calibration module 63 may adjust drive values or a device profile associated with the display device to ensure uniform color output. Although illustrated as a separate module, calibration module 63 may be an integrated feature of a color management system. Any calibration technique may be used in accordance with the invention. Indeed, the actual calibration process used may depend on a number of factors including the type of display devices implemented in viewing stations 12. Nevertheless, high quality calibration techniques are preferred because they may result in improved color accuracy.

As one example, copending and commonly assigned application Ser. No. ______ filed the same day as this application for Christopher Edge, entitled “CALIBRATION TECHNIQUES FOR IMAGING DEVICES” and bearing attorney docket number 10314US01 describes one acceptable calibration process. Briefly, the calibration process involves characterizing the imaging device (in this case a cathode ray tube) with a device model such that an average error between expected outputs determined from the device model and measured outputs of the imaging device is on the order of an expected error, and adjusting image rendering on the imaging device to achieve a target behavior. In this manner, the device model may achieve a balance between expected output and measured results. A correction can then be applied at the video card to achieve a specified target behavior, i.e., RGB gamma values of approximately 2.2. This correction implementing a balance between expected output and measurement can result average color errors less than 0.75 delta e. The entire content of the above-identified application is hereby incorporated herein by reference.

Regardless of the specific calibration process that is implemented, calibration module 63 stores a record (or time-stamp) of the most recent calibration process. Thus, viewing software 62 can simply interact with calibration module 63 or a record created by the calibration module to access the time-stamp and thereby determine whether the last calibration process was performed within the administrator specified minimum time X since last calibration. If not, viewing software 62 can instruct the user accordingly. In other words, if the viewing conditions have not been met, viewing software 62 can cause instruction messages to be displayed. The display of the instruction screen may occur in normal fashion. In that case, the instruction message can be provided to display driver 65, which in turn can provides the necessary signals to video card 66 so that display device 64 renders a message to the user, informing the user that the image cannot be displayed, and possibly instructing the user to calibrate the display in order to view the image.

On the other hand, if viewing software 62 determines that that the last calibration process was performed within the administrator-specified minimum time X, viewing software 62 can authorize or otherwise allow the image to be viewed. In that case, viewing software 62 may pass the RGB data to color matching module 67. Color matching module 67 may convert the RGB data to R′G′B′ data using a dynamic color profile for display 64, i.e., a destination device profile. In other words, color matching module 67 may use the calibration information provided by calibration module 63 to dynamically generate an accurate color profile for display 64. Thus, the device profile is dynamic in the sense that it is modified in response to the calibration process. The converted R′G′B′ data can then be sent to display driver 65 and video card 66 to ultimately drive the pixels of display 64 in a manner that yields a more accurate rendition of the color images.

Viewing software 62 can be realized with web browser software or any image viewing software such as software implementing a GIF, TIFF, or JPEG viewer. Viewing software 62 may incorporate the Adobe Acrobat viewing software, or a web browser such as Netscape Navigator, Windows Explorer, Opera, or any other web browser. In one embodiment, viewing software 62 may include conventional web browser software, with a browser plug-in programmed to perform the non-conventional viewing authorization and viewing restriction techniques described herein. In other words, the viewing authorization and viewing restriction techniques may be embodied as a new and useful improvement to conventional viewing software, and can be easily added as a plug-in.

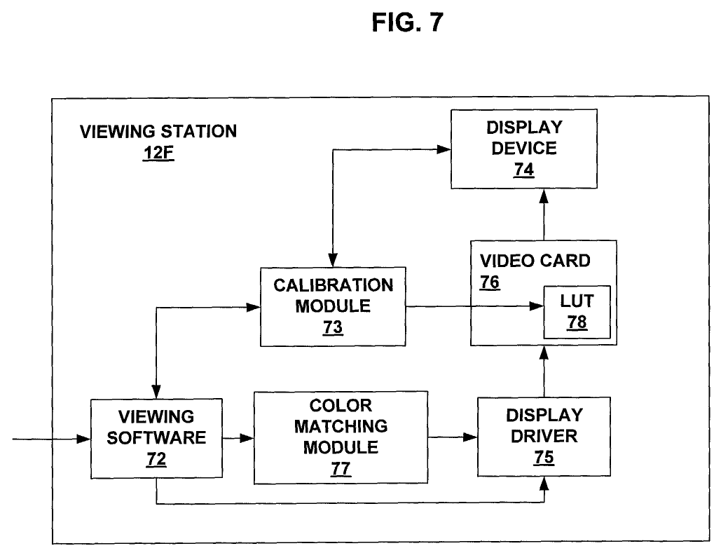

FIG. 7 illustrates another of viewing station 12F. Again, viewing station 12F may correspond to any viewing station 12A-12D illustrated in FIG. 1. Viewing software 72 operates in manner substantially similar to viewing software 62 illustrated in FIG. 6. However, in the embodiment of FIG. 7, color matching module 77 applies a static color profile of display 74 that does not account for calibration measurements determined by calibration module 73. Rather, in FIG. 7, the calibration measurements are used to modify entries in a look-up table (LUT 78) that is stored on video card 76. Thus, once viewing software 72 authorizes the viewing of an image, it is fed through color matching module 77 to convert the RGB data using a static color profile of display 74. The color data can then be sent through display driver 75 and into video card 76. Within video card 76, the color data may be applied to LUT 78 to adjust the color data according to calibration information provided by calibration module 73. Video card 76 can then drive the pixels of display 74 in a manner that yields a very accurate rendition of color images.

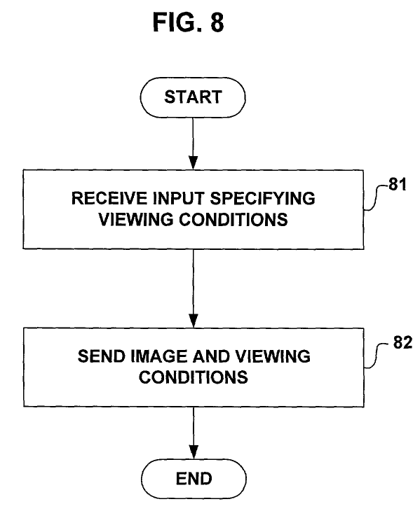

FIG. 8 is a high level flow diagram illustrating a technique that can be implemented in a soft proofing system. As shown, administrative computer 10 receives input specifying one or more viewing conditions (81). For example, an administrator can simply enter or choose the desired viewing conditions for a given image or a collection of images. The image and the viewing conditions can then be sent from administrative computer 10 to one or more viewing stations 12 (82). The viewing conditions may be integrated within image files sent by administrative computer 10 or sent independently of the image files. For example, administrative computer 10 may serve images either automatically or in response to requests from one or more viewing stations 12 via a network connection.

In another embodiment, the administrator may set viewing conditions for one or more folders on the network drive. In that case, the folder to which the viewing conditions apply is called a “hot folder.” Any time an image is served to a viewing station 12 from the hot folder, the viewing conditions for that hot folder may also be served. In this manner, the administrator may have more control over viewing conditions for a collection of images. Moreover, after setting viewing conditions for the hot folder, an administrator may not be required to reenter the viewing conditions for images created or added to the system at a later date. Rather, the administrator can simply add the new image to the hot folder. In that case, the viewing conditions for the hot folder can apply to the newly added image, without requiring the administrator to reenter the viewing conditions. This can save time, and allow viewing conditions to be set in a uniform manner across several images. The hot folder may also be accessible only by particular users, or at particular viewing stations. In that case, one or more user identifications or viewing station identifications may comprise a viewing condition that can be chosen by the administrator.

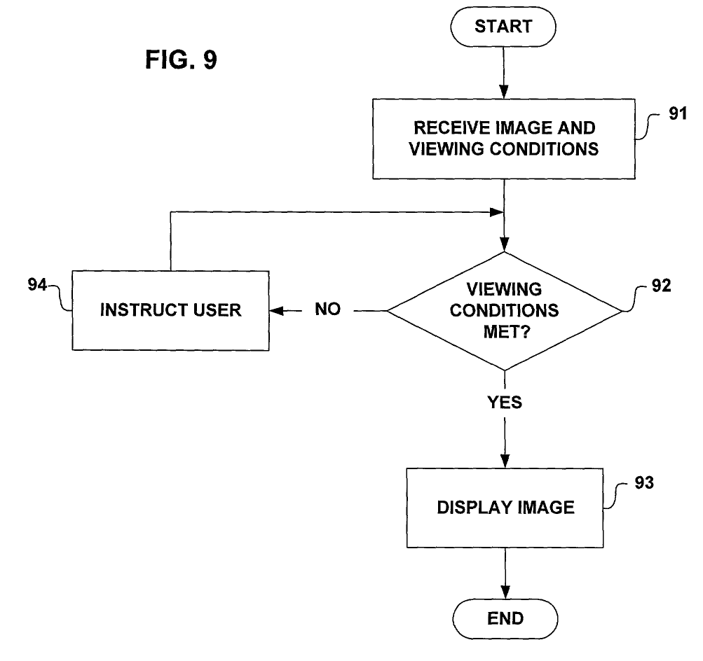

FIG. 9 is another flow diagram according to the invention. After administrative computer 10 has sent the image and viewing conditions, viewing station 12 receives them (91). Viewing station 12 then checks to determine whether the viewing conditions have been met (92). If so, the image can be displayed (93). If not, the user may be instructed (94). To determine whether the viewing conditions have been met, the viewing software 12 may query time stamps in the system, or other check one or more viewing conditions or timing associated with the viewing conditions, such as the time since last calibration or the time since the display device was turned on.

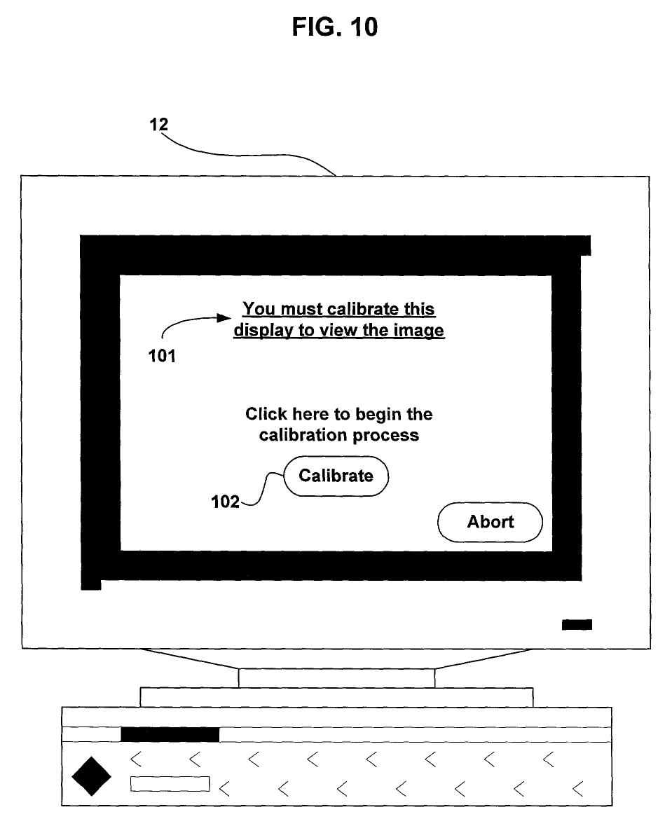

FIG. 10 illustrates one exemplary instruction screen that can be displayed at viewing station 12 in the event that the display has not been calibrated within an acceptable amount of time. In particular, the instruction screen may display an indication to the user that the image cannot be displayed 101. In addition, the instruction screen may also indicate corrective measures that the user can take in order to view the image. In that case, the user may be instructed to initiate a calibration process in order to view the image simply by clicking the calibrate icon 102.

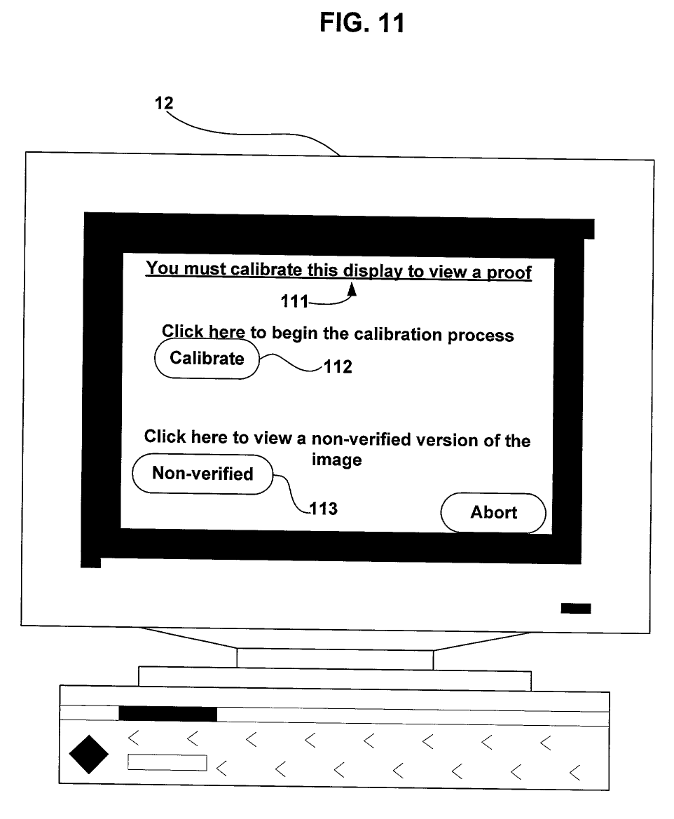

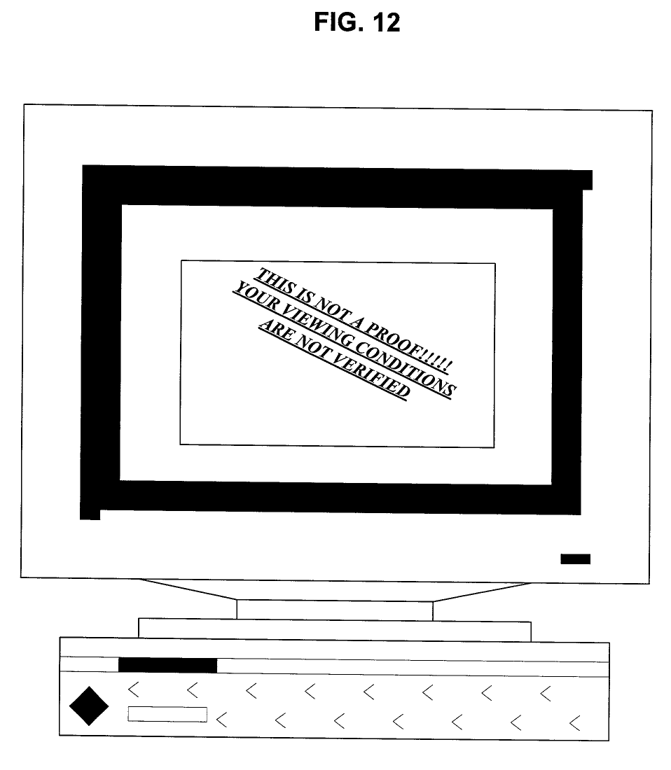

FIG. 11 illustrates another exemplary instruction screen that can be displayed at viewing station 12 in the event that the display has not been calibrated within an acceptable amount of time. Again, the instruction screen may display an indication to the user that the image cannot be displayed 111, along with instructions for corrective measures that the user can take in order to view the image, such as an instruction to click the calibrate icon 112 in order to initiate a calibration routine. In addition, the instruction screen may allow the user to view a non-verified version of the image, e.g., by clicking the non-verified icon 113. In that case, the image may be viewed by the user even though the calibration process was not performed within the time frame specified by the administrator. However, the non-verified rendition of the image may be conspicuously labeled as such, and the ability of the user to annotate or provide feedback regarding the image may be limited or restricted. If users are allowed to annotate the non-verified image, the annotations may be conspicuously labeled as coming from a user that viewed a non-verified image. In that case, viewing software 12 may cause annotations to appear accordingly. For example, Adobe Acrobat viewing software allows annotations to be labeled according to the source of the annotations. Thus, the annotations are additions to the image file. In accordance with the invention, the viewing software may add annotations in the form of additions to the image file that indicate that the annotations come from a user that viewed a non-verified image. FIG. 12 illustrates an exemplary view of a display screen that can be displayed in response to the users selection of the non-verified icon 113.

As mentioned above, the viewing conditions are subject to a wide variation of possible variables. One mentioned variable is a warm-up condition. In that case, the ability to view an image may be restricted if the display has not been adequately warmed up. In some cases, one or more viewing conditions can be automatically specified in the viewing software loaded on viewing stations 12. In that case, an administrator would not even need to specify the viewing conditions. Rather, viewing software would automatically check the viewing conditions prior to authorizing viewing of an image. For example, in some systems it may be advantageous to require a user to calibrate the display device prior to viewing. In that case, calibration parameters may be automatically specified in the viewing condition software. Until the display device is calibrated, the ability to view the image may be restricted whether or not the administrator specified calibration information as part of the viewing conditions.

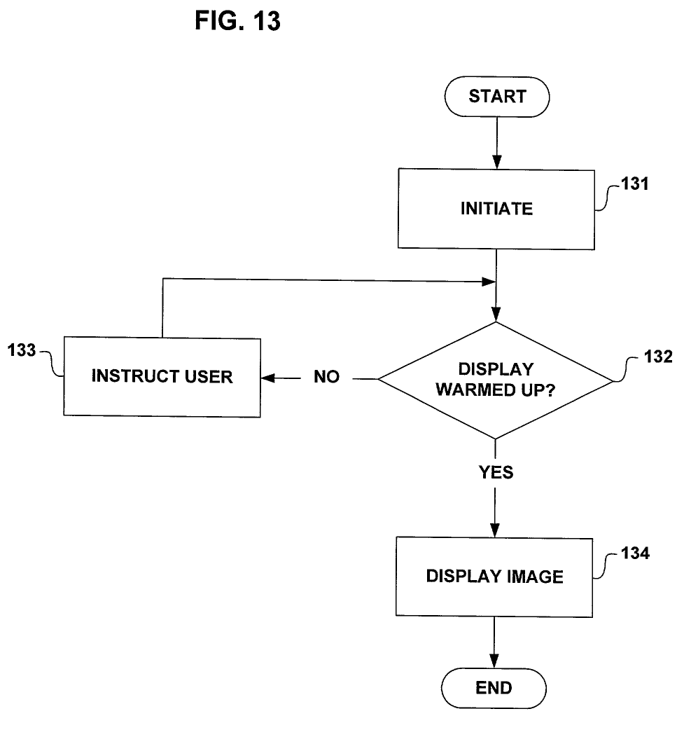

FIG. 13 illustrates a soft proofing technique wherein a viewing condition is an automatic feature of viewing condition software. In that case, an administrator would not need to specify the condition. Rather, the viewing software at the viewing station would automatically check the condition. Although FIG. 13 illustrates a warm-up condition as being automatic feature of the viewing software, other viewing conditions, including calibration conditions could also be specified in the software so that an administrator would not need to specify the conditions.

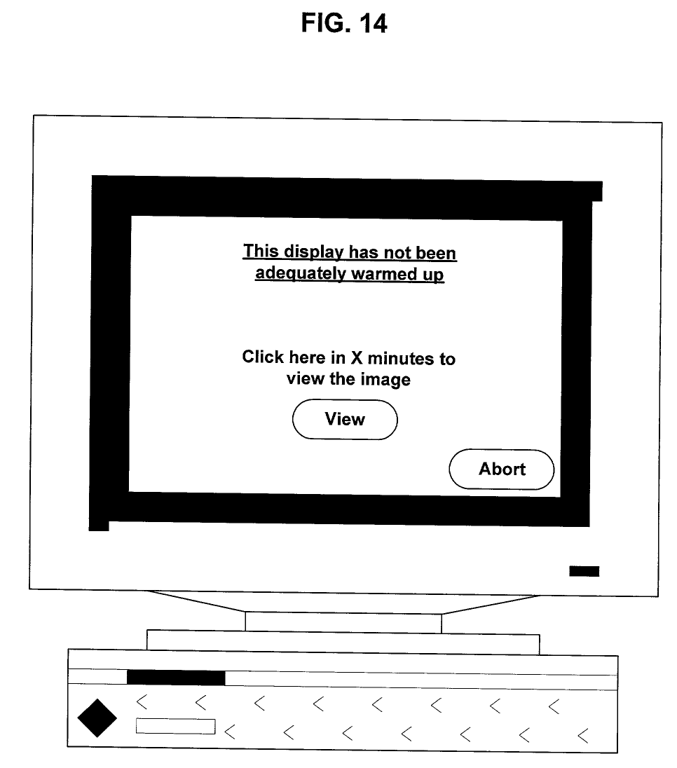

As shown, a user at a viewing station 12 initiates the viewing of a soft-proof (131). For example, initiation may take place when a user requests an image file from administrative computer 10, e.g., from a network folder. Viewing condition software on the viewing station 12 determines whether a display device at viewing station 12 has been adequately warmed up (132). For example, the display device may initiate a time stamp upon being turned on, or alternatively, the display device may be coupled to the same power source as a CPU at the viewing station. In the later case, a time stamp of the CPU indicating when it was last turned on may be used to identify when the display device was last turned on. If the display device has not been adequately warmed up, the user is instructed as such, and viewing rights may be temporarily restricted (133). FIG. 14 illustrates an example display screen that a user may encounter when a display has not been adequately warmed-up. If the display has been warmed up, the viewing software may direct viewing station 12 to display the image (134).

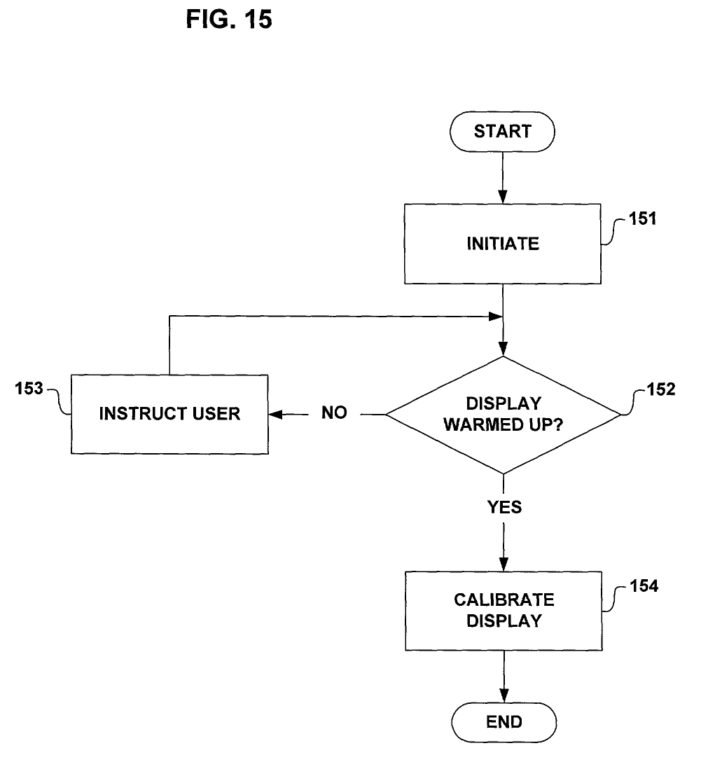

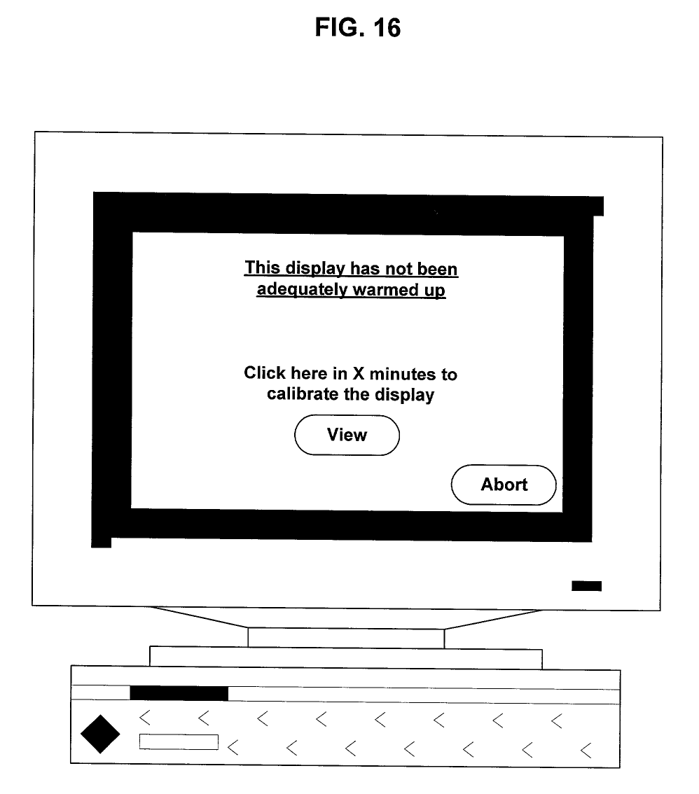

FIG. 15 illustrates a combined technique. In particular, the technique of FIG. 15 recognizes that calibration of a display device should not occur until the display has been adequately warmed up, and thus reached a steady viewing state. Therefore, upon initiation of a calibration process (151), viewing software determines whether the display has been adequately warmed up (152). If not, the user is instructed that the display has not been adequately warmed up (153). FIG. 16 illustrates one example. However, if the display has been warmed up, then the calibration process may be performed (154).

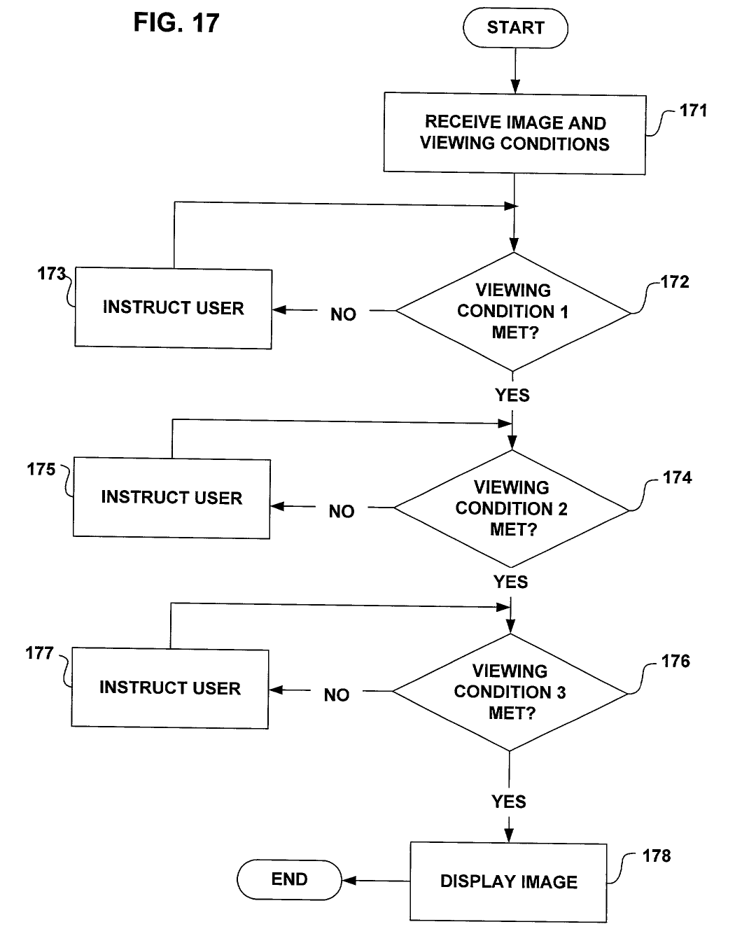

FIG. 17 is another flow diagram according to the invention. As shown, viewing station 12 receives an image and viewing conditions (171). Viewing station 12 determines whether a first viewing condition has been satisfied (172). If not, a user at the viewing station is instructed (173). If so, viewing station 12 proceeds to determine whether a second viewing condition has been satisfied (174). Again, if the condition has not been satisfied, the user at the viewing station 12 is instructed (175). Once both the first and second viewing conditions have been satisfied, viewing station 12 proceeds to determine whether a third viewing condition has been satisfied (176), and instructs the user in the event that third condition has not been satisfied (177). This process may continue for any number of viewing conditions. Alternatively, every viewing condition may be checked substantially simultaneously at viewing station. In either case, once all of the viewing conditions have been satisfied, viewing station 12 displays the image (178). A user at the viewing station 12 can then review the image, and possibly provide feedback by annotating the image and returning the annotated version of the image to administrative computer 10.

A number of techniques and embodiments of the invention have been described. The techniques may be implemented in software, hardware, firmware or any combination of hardware, software and firmware. If implemented in software, the techniques may be embodied in program code initially stored on a computer readable medium such as a hard drive or magnetic, optical, magneto-optic, phase-change, or other disk or tape media. For example, the program code can be loaded into memory and then executed in a processor. Alternatively, the program code may be loaded into memory from electronic computer-readable media such as EEPROM, or downloaded over a network connection. If downloaded, the program code may be initially embedded in a carrier wave or otherwise transmitted on an electromagnetic signal. The program code may be embodied as a feature in a program providing a wide range of functionality.

If the invention is implemented in program code, the processor that executes the program code may take the form of a microprocessor and can be integrated with or form part of a PC, Macintosh, computer workstation, a hand-held computer, or any other computer. The memory may include random access memory (RAM) storing program code that is accessed and executed by a processor to carry out the various techniques described above.

Exemplary hardware implementations may include implementations within a DSP, an application specific integrated circuit (ASIC), a field programmable gate array (FPGA), a programmable logic device, specifically designed hardware components, or any combination thereof.

Although various aspects of the invention have been described in the context of a soft proofing system that includes an administrator and a number of viewing stations, various aspects of the invention are not necessarily limited in that respect. For instance, a number of the techniques described herein may be implemented in a stand-alone computer, or a network of interconnected computers that does not have a specified administrator. In those cases, the raster image processing and CMYK to RGB conversions may be performed locally rather than by an administrator. Also, although many aspects of the invention have been described in a system that implements CRT displays, the invention is readily applicable to systems that implement other types of displays including liquid crystal displays (LCDs), plasma displays, and the like. Accordingly, other implementations and embodiments are within the scope of the following claims.

1. A soft proofing system comprising:
a first computer that specifies one or more viewing conditions of an image; and
a viewing station that displays the image subject to the viewing conditions.

2. The system of claim 1, wherein the viewing conditions comprise calibration information indicating a required calibration state of a display device associated with the viewing station.

3. The system of claim 1, wherein the viewing conditions comprise calibration information that specify a maximum amount of time since a display device at the viewing station was last calibrated.

4. The system of claim 3, wherein the viewing station automatically prompts a user to calibrate the display device when the display device has not been calibrated within the maximum amount of time.

5. The system of claim 3, wherein the calibration information causes the viewing station to automatically prompt a user to calibrate the display device in order to view the image.

6. The system of claim 1, wherein the viewing conditions comprise warm-up information that cause the viewing station to restrict display of the image when a display device of the viewing station has not been turned on for an amount of time.

7. The system of claim 1, wherein the viewing conditions include information specifying one or more sharpening techniques to be applied at the viewing station.

8. The system of claim 1, wherein the viewing station displays the image by converting image data from a first coordinate system to a second coordinate system and driving a display device according to the converted image data.

9. The system of claim 1, wherein the viewing station does not permit modification of the viewing conditions.

10. The system of claim 1, wherein the viewing station displays a notification in the event any of the viewing conditions are modified by a user at the viewing station.

11. A method comprising:
receiving image data and viewing conditions; and
restricting display of an image according to the image data when the viewing conditions are not satisfied.

12. The method of claim 1 1, wherein the viewing conditions comprise calibration information indicating a required calibration state of a display device associated with a viewing station.

13. The method of claim 11, wherein the viewing conditions comprise calibration information that specify a maximum amount of time since a display device at the viewing station was last calibrated.

14. The method of claim 13, further comprising prompting a user to calibrate the display device when the display device has not been calibrated within the maximum amount of time.

15. The method of claim 12, further comprising prior to displaying the image, prompting a user to calibrate a display device at the viewing station in order to view the image.

16. The method of claim 11, further comprising displaying the image according to the image data only when the viewing conditions have been met and a viewing station has been turned on for an acceptable amount of time.

17. The method of claim 11, wherein the viewing conditions comprise warm-up information that specifies an amount of time, the method further comprising displaying the image according to the image data only when a display device at a viewing station has been turned on for the amount of time.

18. The method of claim 11, wherein displaying the image according to the image data comprises converting the image data from a first coordinate system to a second coordinate system and driving a display device according to the converted image data.

19. A method comprising:
specifying viewing conditions for an image; and
sending the image and the viewing conditions to a viewing station, wherein the viewing station displays the image subject to the viewing conditions.

20. The method of claim 19, further comprising limiting access to the viewing conditions such that a user at the viewing station cannot change the viewing conditions.

21. A computer readable medium carrying program code that when executed:
receives an image and viewing conditions for the image; and
restricts display of the image when the viewing conditions are not satisfied.

22. The computer readable medium of claim 21, wherein the viewing conditions comprise calibration information that specifies an amount of time, wherein the program code when executed restricts display of the image unless a display device at a viewing station has been calibrated within the amount of time.

23. The computer readable medium of claim 22, wherein the program code when executed prompts a user to calibrate the display device at the viewing station when the display device has not been calibrated within the amount of time.

24. The computer readable medium of claim 21, wherein prior to displaying the image, the program code when executed prompts a user to calibrate a display device at a viewing station in order to view the image.

25. The computer readable medium of claim 21, wherein the program code when executed restricts display of the image when a display device of a viewing station has not been turned on for an acceptable amount of time.

26. The computer readable medium of claim 21, wherein the program code when executed displays the image by converting image data from a first coordinate system to a second coordinate system and driving a display device according to the converted image data.

27. A computer readable medium carrying program code that when executed:
receives input specifying viewing conditions for an image; and
sends the image and the viewing conditions to a viewing station, wherein the viewing station restricts display of the image unless the viewing conditions are satisfied.

28. The computer readable medium of claim 27, wherein the program code when executed limits access to the viewing conditions such that a user at the viewing station cannot change the viewing conditions.

29. The computer readable medium of claim 27, wherein the viewing conditions comprise calibration information indicating a required calibration state of a display device associated with the viewing station.

30. The computer readable medium of claim 27, wherein the viewing conditions comprise warm-up information indicating a required amount of time that a display device associated with the viewing station must be turned on.

31. The computer readable medium of claim 27, wherein the viewing conditions include information specifying one or more sharpening techniques to be applied at the viewing station.

32. A computer readable medium storing an image file that includes image data and viewing conditions, wherein access to the image data at a viewing station is restricted by the image file when the viewing conditions have not been met.

33. The computer readable medium of claim 32, wherein the viewing conditions comprise calibration information indicating a required calibration state of a display device associated with the viewing station.

34. The computer readable medium of claim 32, wherein the viewing conditions comprise warm-up information indicating a required amount of time that a display device associated with the viewing station must be turned on.

35. The computer readable medium of claim 32, wherein the viewing conditions include information specifying one or more sharpening techniques to be applied at the viewing station.

36. The computer readable medium of claim 32, wherein the image file includes enabling data that can enable and disable the viewing conditions, wherein access to the image data at the viewing station is restricted by the image file when the viewing conditions have not been satisfied and the enabling data enables the viewing conditions, and wherein access to the image data is not restricted at the viewing station when the enabling data disables the viewing conditions.

37. The computer readable medium of claim 32, wherein access to the viewing conditions within the image file is restricted such that only an administrator can change the viewing conditions.

38. A method comprising:
determining an amount of time that a display device has been turned on; and
restricting viewing of an image when the display device has not been turned on for an acceptable amount of time.

39. The method of claim 38, further comprising informing a user when the image can be viewed.

40. The method of claim 38, further comprising launching a calibration procedure only after the display device has been turned on for the acceptable amount of time.

41. A method comprising:
determining an amount of time that a display device has been turned on; and
restricting a calibration procedure for the display device when the display device has not been turned on for an acceptable amount of time.

42. The method of claim 41, further comprising restricting viewing of an image when the display device has not been turned on for the acceptable amount of time.

43. A computer readable medium carrying program code that when executed:
determines an amount of time that a display device has been turned on; and
restricts viewing of an image when the display device has not been turned on for an acceptable amount of time.

44. A computer readable medium carrying program code that when executed:
determines an amount of time that a display device has been turned on; and
restricts a calibration procedure for the display device when the display device has not been turned on for an acceptable amount of time.

45. A method comprising:
receiving an image at a viewing station; and
restricting an ability of a user to proof the image at the viewing station when viewing conditions have not been satisfied at the viewing station.

46. The method of claim 45, wherein restricting comprises restricting viewing of the image.

47. The method of claim 45, wherein restricting comprises restricting an ability to annotate the image.

48. The method of claim 45, wherein the viewing conditions comprise calibration information indicating a required calibration state of a display device associated with the viewing station.

49. The method of claim 45, wherein the viewing conditions comprise warm-up information indicating a required amount of time that a display device associated with the viewing station must be turned on.

50. The method of claim 45, wherein the viewing conditions include information specifying one or more sharpening techniques to be applied at the viewing station.

51. A method comprising:
receiving an image at a viewing station; and
displaying the image with conspicuous marking indicating that the image is not verified when viewing conditions have not been satisfied at the viewing station.

52. The method of claim 51, further comprising displaying the image with annotations, wherein the annotations are conspicuously marked as being added during non-verified viewing.

53. A computer readable medium storing a folder of images and meta data file associated with the folder, wherein the meta data file includes viewing conditions for all images in the folder.

54. A soft proofing system comprising:
a first computer that specifies one or more viewing conditions of a set of images image in a folder by setting the viewing conditions in a meta data file associated with the folder; and
a viewing station that displays one or more of the images subject to the viewing conditions.
